(19) United States
(12) Patent Application Publication
(10) Pub. No.: US 2001/0006364 A1
(43) Pub. Date: Jul. 5, 2001

(54) Low profile transformer

(76) Inventors: Kuan-Ting Lin, Pan Chao City (TW); Yeh Ming, Pan Chao City (TW); Heng-Cheng Chou, Taipei (TW); Ren-Jye Huang, Tao Yuan (TW); Hui-Hua Teng, Tao Yuan (TW); Jau-Jen Du, Taipei (TW); Chien-Chia Lin, Tao Yuan (TW)

Correspondence Address: DOUGHERTY & TROXELL, SUITE 1404, 5205 LEESBURG PIKE, FALLS CHURCH, VA, 22041, US

(21) Appl. No.: 09/730,848

(22) Filed: Dec. 7, 2000

Related U.S. Application Data
(63) Continuation-in-part of application No. 09/447,345, filed on Nov. 22, 1999, now abandoned.

(51) Int. Cl. H01F 5/00

(52) U.S. Cl. 336/200

(57) ABSTRACT

The invention discloses the design of a low profile transformer, which is smaller in size and lighter in weight. The low profile transformer will meet the isolation safety standard and is manufactured with low cost. Furthermore, a variety of cores could be applied to the low profile transformer for a wide range of electrical current loading.

### RELATED APPLICATIONS

This is a Continuation-In-Part (CIP) of pending patent application U.S. Ser. No. 09/447,345 filed on Nov. 22, 1999 and entitled “Low Profile Transformer”.

### BACKGROUND OF THE INVENTION

1. Field of the Invention

The present invention relates to a low profile transformer, and, more particularly, to a low profile transformer that uses a PC board with several spiral traces as the primary windings, and uses insulation wires as the secondary windings of the low profile transformer.

2. Description of the Prior Art

A transformer device is a fairly important device for an electric or an electronic system. A transformer can be operated not only as a power supplier and a voltage transformer, but also as an energy storage device. According to conventional transformers, wires were utilized as primary windings and secondary windings. Availability of the materials and ease of design are the advantages of the conventional transformer. However, because of its large area in order for winding the wires and isolating the wires, the conventional transformer has a high profile and occupies a large area on a PC board, violating the present demand for smaller and lighter transformers.

Referring now to FIG. 1, the structure of a conventional transformer is shown. The transformer contains a pair of ferrite cores, i.e. the top ferrite core 2 and the bottom ferrite core 3, which are located on a bobbin 1. The primary windings and the secondary windings of the transformer are wound around the bobbin 1. The windings 11 are wound around the bobbin 1, and the edge of the windings 11 and the bobbin 1 are enveloped by edge tape 13 and then further by an insulating tape 12. The usage of the bobbin for a transformer causes the high profile. This results in a transformer being the largest and biggest component on a PC board.

On the other hand, U.S. Pat. No. 5,010,314 discloses a low profile transformer to overcome the problem of the high profile. The low profile transformer is formed by stacking the components layer by layer. Its main drawbacks are that the stacking layers are too many and its structure is too complicated. The drawbacks result in the complexity of electric design and also enhance the manufacturing cost. The present invention will overcome the issue of high profile and meet the international safety standard.

Therefore, an object of this invention is to provide a low profile transformer design and physical structure that easily meets the international safety standard.

It is a further object of this invention to provide a low profile transformer, in order to avoid large sizes in the electric system.

It is yet another object of this invention to provide a low profile transformer, in order to shorten the cycle time of production and thus to save production cost.

It is a further objection of this invention to provide a low profile transformer, wherein said transformer is available for a large range of current loadings. This means that the transformer according to the present invention can use a variety of types of ferrite cores.

### SUMMARY OF THE INVENTION

These and other objects are achieved in a low profile transformer with a structure comprising: a top core and a bottom core defining a magnetic path, wherein each core has a central projection; a top PC board and a bottom PC board with several spiral traces as primary windings of said transformer, wherein each PC board has a hole in the middle, such that the central projections of the cores penetrate into the holes of the PC boards to form a structure with a low profile; and an insulation wire, wherein the insulation wire is wound round the central projections of the cores as the secondary winding of the transformer.

The primary and secondary windings structure are largely modified in the present invention. The ferrite cores could be an EE type, EI type, ER type, Cut type, or any other types of ferrite cores.

The ferrite cores according to the present invention sandwich the PC boards and the insulation wire, so that the height of the transformer is just a combination of the cores.

The transformer according to the present invention further includes a top insulating layer and a bottom insulating layer, wherein the top insulating layer is located between the top core and the top PC board, and the bottom insulating layer is located between the bottom core and the bottom PC board.

The transformer according to the present invention further includes insulators adjacent to the secondary windings of the transformer, in order to avoid short-circuiting from the primary windings to the secondary windings.

The transformer according to the present invention further includes fix rods located at one side of the top PC board and the bottom PC board, in order to fix the PC boards.

The insulation wire according to the present invention could be made of a copper sheet directly coated on a PC board as the secondary windings.

The surface of the copper sheet is further covered by insulators adjacent to the secondary windings of said transformer.

### BRIEF DESCRIPTION OF THE DRAWINGS

A more complete understanding of the invention can be obtained by considering the following detailed description in conjunction with the accompanying drawing, in which:

FIG. 1 is an exploded view of a transformer assembly according to a prior art.

FIG. 2A is an exploded view of a low profile transformer assembly according to a first embodiment of the present invention.

FIG. 2B is a three dimensional view of a low profile transformer assembly according to the first embodiment of the present invention.

FIG. 3 is a side view of a low profile transformer assembly according to the first embodiment of the present invention.

FIG. 4 is a front plan view of a low profile transformer assembly according to the first embodiment of the present invention.

FIG. 5 is an exploded view of a low profile transformer assembly according to a second embodiment of the present invention.

FIG. 6A is an exploded view of a low profile transformer assembly according to a third embodiment of the present invention.

FIG. 6B is a three dimensional view of a low profile transformer assembly according to the third embodiment of the present invention.

FIG. 7 is an exploded view of a low profile transformer assembly according to a fourth embodiment of the present invention.

FIG. 8A is a top view of a planar ferrite core according to the present invention.

FIG. 8B is a side view of a planar ferrite core according to the present invention.

FIG. 9 is a side view of a low profile transformer assembly according to a fifth embodiment of the present invention.

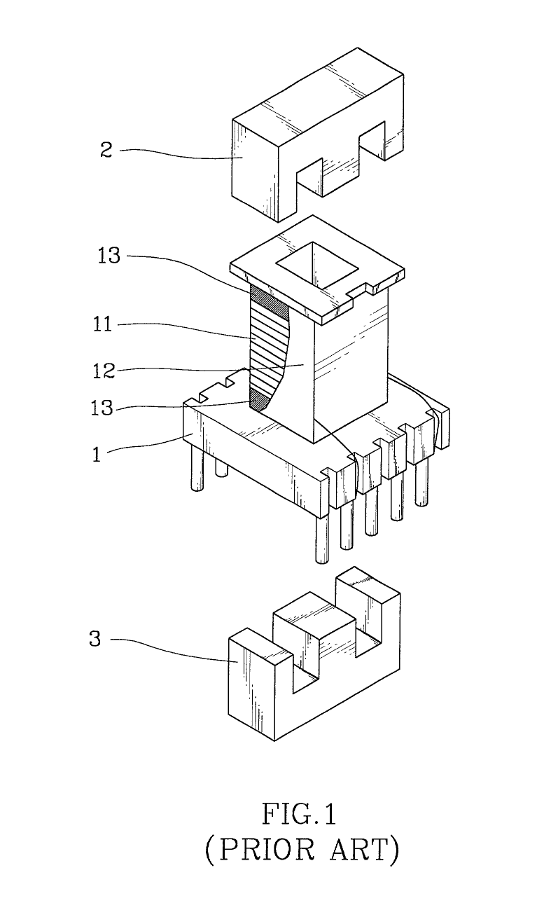

### DETAILED DESCRIPTION OF THE PREFERRED EMBODIMENTS

The present invention relates to the design of a low profile transformer, which is small in size and light in weight. The low profile transformer will meet the isolation safety standard and can be manufactured with low cost. Furthermore, a variety of types of ferrite cores can be applied to the low profile transformer for a wide range of electrical current loadings.

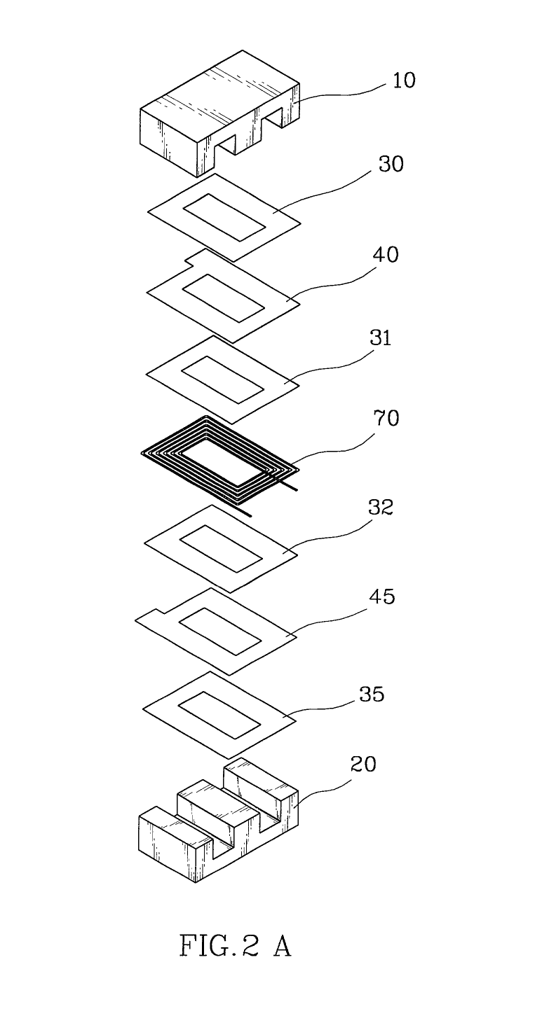

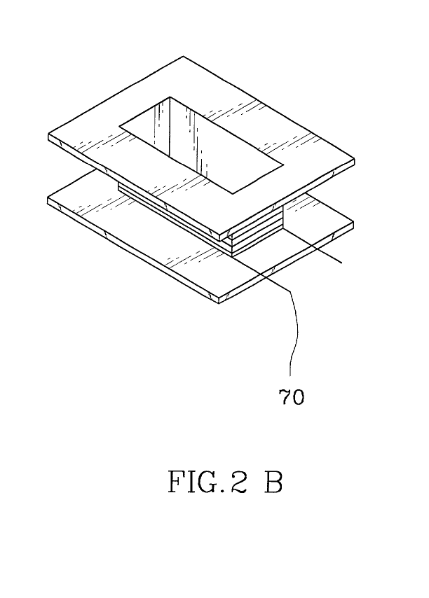

The low profile transformer of the present invention is obtained by modifying the structures of the primary windings and the secondary windings used in the prior art. FIG. 2A depicts an exploded view of the low profile transformer according to a first embodiment of the present invention, which is mainly used for applications of small current loadings. The low profile transformer contains ferrite cores, i.e. the top ferrite core 10 and the bottom ferrite core 20, which are operated as a magnetic housing. Typically, the magnetic housing is made of ferrite, Sumarium or some other composite material that is shaped as EE core, as shown in FIG. 2A. In addition, the other types of ferrite cores, such as EI core, ER core, EE core, or Cut type, are also available in the other embodiments of the present invention.

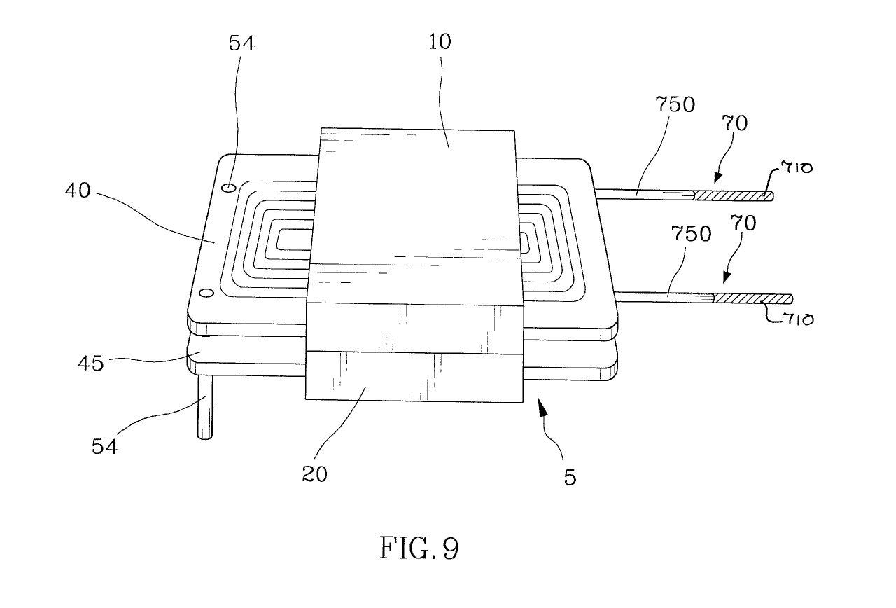

The low profile transformer shown in FIG. 2A further contains PC boards, i.e. the top PC board 40 and the bottom PC board 45. A structure having only one PC board is also possible, depending on the number of windings around the ferrite cores. A number of spiral traces (not shown in FIG. 2A) are laid out on each PC board 40, 45 as the primary windings of the transformer. In order to form a low-profile structure, each PC board has a hole in the middle, such that the central projections of the top ferrite core 10 and the bottom ferrite core 20 can penetrate into the holes. The transformer further contains insulation wires 70, wound on the central projections of the top ferrite core 10 and the bottom ferrite core 20, as the secondary windings. The use of triple insulation wires wound on the ferrite cores is also possible for the insulation wires 70, as illustrated in FIG. 9.

As described above, the top PC board 40, the bottom PC board 45, and the insulation wires 70 are located between the top ferrite core 10 and the bottom ferrite core 20. Therefore, the height of the transformer is the combination of the top ferrite core 10 and the bottom ferrite core 20. Because the winding area for the primary windings is less than that in the prior art, the projection length of the ferrite cores 10, 20 for the primary windings can be much shorter, such that the purpose of forming a low profile transformer could be achieved.

As shown in FIG. 2A, in order to prevent short-circuiting from the primary windings of the transformer to the secondary windings, the transformer further contains insulating layers, i.e. the top insulating layer 30 and the bottom insulating layer 35, wherein the top insulating layer 30 is located between the top ferrite core and the top of the PC board 40, and the bottom insulating layer 35 is located between the bottom ferrite core 20 and the bottom of the PC board 45. Naturally, the number of insulating layers is decided by actual application. Because there is already an insulating layer on the insulation wires 70, it is also possible to use the structure without any insulating layer. On the other hand, in order for further isolation, some insulating layers 31, 32 can also be inserted into the transformer above the top PC board 40 and below the bottom PC board 45 respectively. FIG. 2B depicts a three dimensional view of the low profile transformer according to the present invention, and shows the differences between the present invention and the prior art.

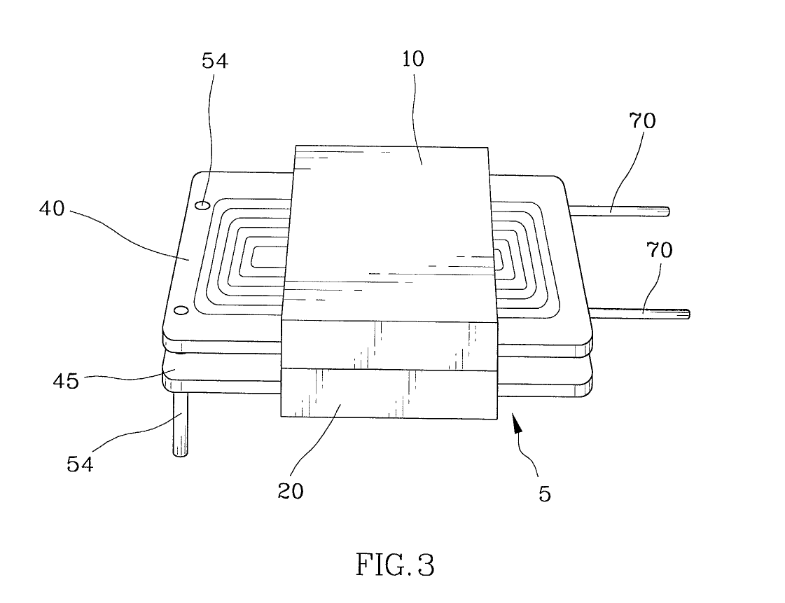

FIG. 3 depicts a side view of a low profile transformer assembly according to the first embodiment of the present invention. As shown in FIG. 3, the transformer 5 according to the present invention is a structure with a low profile. In addition, FIG. 3 also shows the spiral traces on the surface of the top PC board 40, which are the primary windings of the transformer 5. On the other hand, there are also several spiral traces on the surface of the bottom PC board 45. Furthermore, there are fix rods 54 on one side of the top PC board 40 and the bottom PC board 45, which fix the top PC board 40 and the bottom PC board 45.

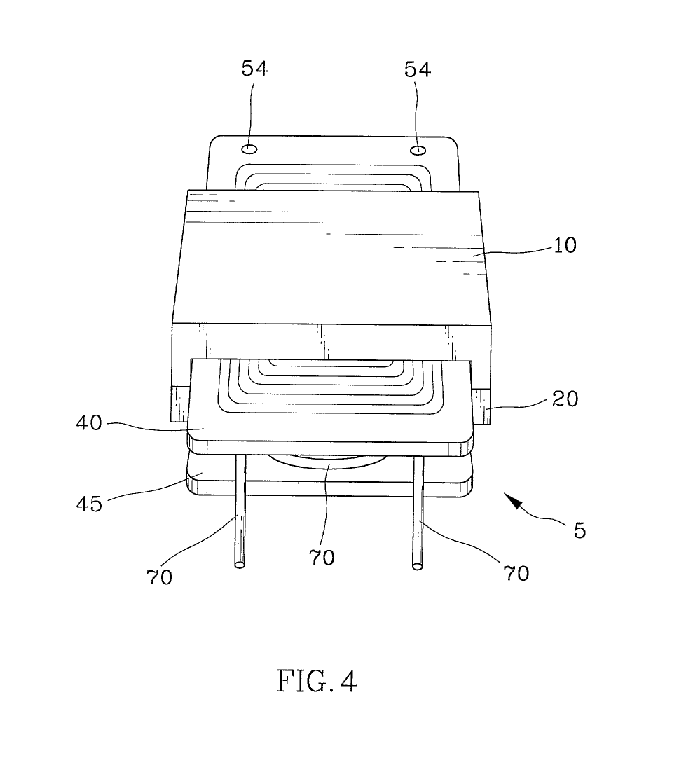

FIG. 4 depicts a front plan view of a low profile transformer assembly according to the first embodiment of the present invention. As shown in FIG. 4, the transformer 5 has a low profile with fix rods 54 in front of the top PC board 40 and the bottom PC board 45.

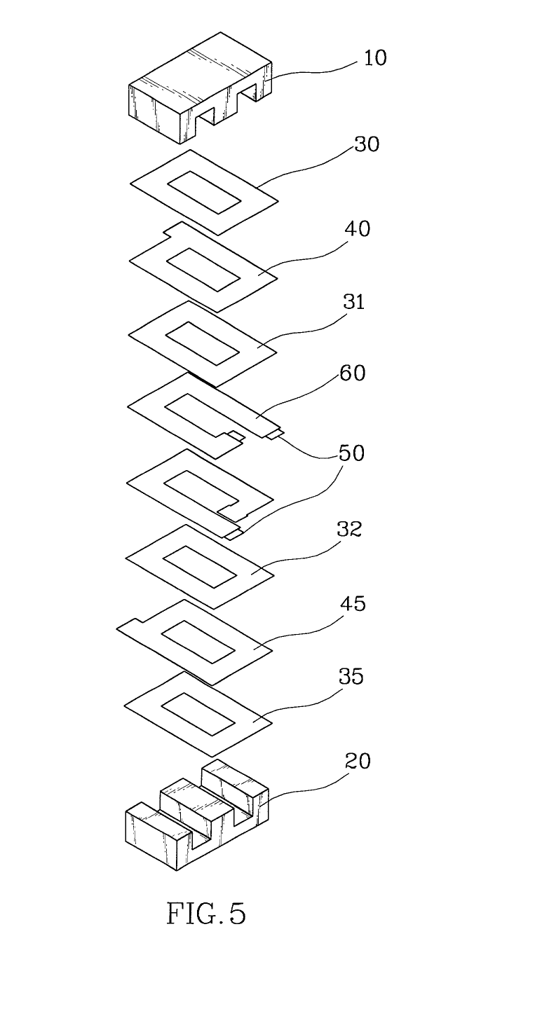

Please refer now to FIG. 5 for the second embodiment of the present invention. FIG. 5 is an exploded view of a low profile transformer assembly according to the second embodiment of the present invention, which is mainly used for large current loadings. Copper sheets 50 replace the secondary windings used in the first embodiment. Actually, it depends on the application requirements to decide how many (one or multiple) copper sheets 50 are needed. Each copper sheet has a thickness of less than 0.4 mm and is covered by an insulating layer 60 to avoid short-circuiting to the primary windings. The other elements in FIG. 5 according to the second embodiment, such as the top ferrite core 10, the bottom ferrite core 20, the top PC board 40, and the bottom PC board 45, are like those in FIG. 2 according to the first embodiment. In addition, several insulating layers 30, 35, 31, 32 (could be multilayers) in FIG. 2 according to the first embodiment could also be used in FIG. 5 according to the second embodiment.

Furthermore, though the EE ferrite core is illustrated in FIG. 5, other types of ferrite cores, such as EI core, ER core, or Cut type, may also be used in the second embodiment of the present invention.

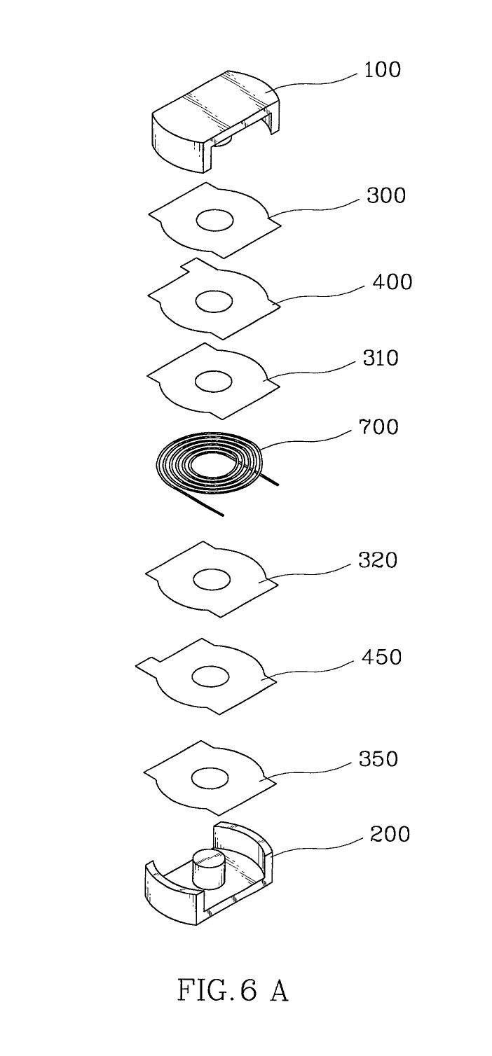

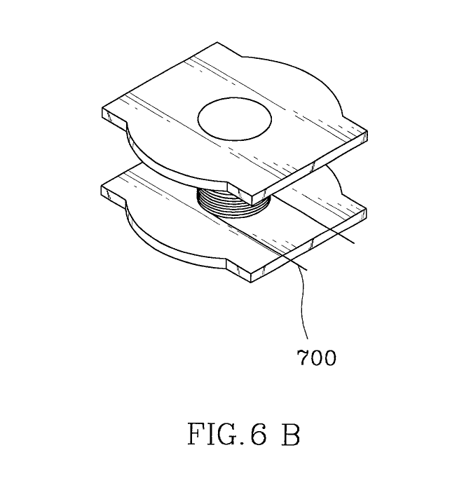

Referring now to FIG. 6A, it is an exploded view of a low profile transformer assembly according to a third embodiment of the present invention. As shown in FIG. 6A, the top ferrite core 100 and the bottom ferrite core 200 are in the shape of a Cut core type. In order to match the shape of the ferrite cores 100, 200 in the third embodiment, the shapes of the top PC board 400 and the bottom PC board 450 are also modified, as shown in FIG. 6A. In addition, the insulating layers 30, 35, 31, 32 (could be multilayers) used in the first and second embodiments are also replaced by the insulating layers 300, 350, 310, 320 (could be multilayers), in order to match the shape of the ferrite cores 100, 200 in the third embodiment. The spiral traces on the top PC board 400 and the bottom PC board 450 are also operated as the primary windings of the transformer just like in the first and second embodiments. In addition, the secondary windings are the insulation wires 700. The main differences between the third embodiment and the first two are the shapes of the ferrite cores 100, 200, and the shapes of the other elements modified to fit the shape of the ferrite cores. FIG. 6B is a three dimensional view of a low profile transformer assembly according to the third embodiment of the present invention, and shows the differences between the present invention and the prior art.

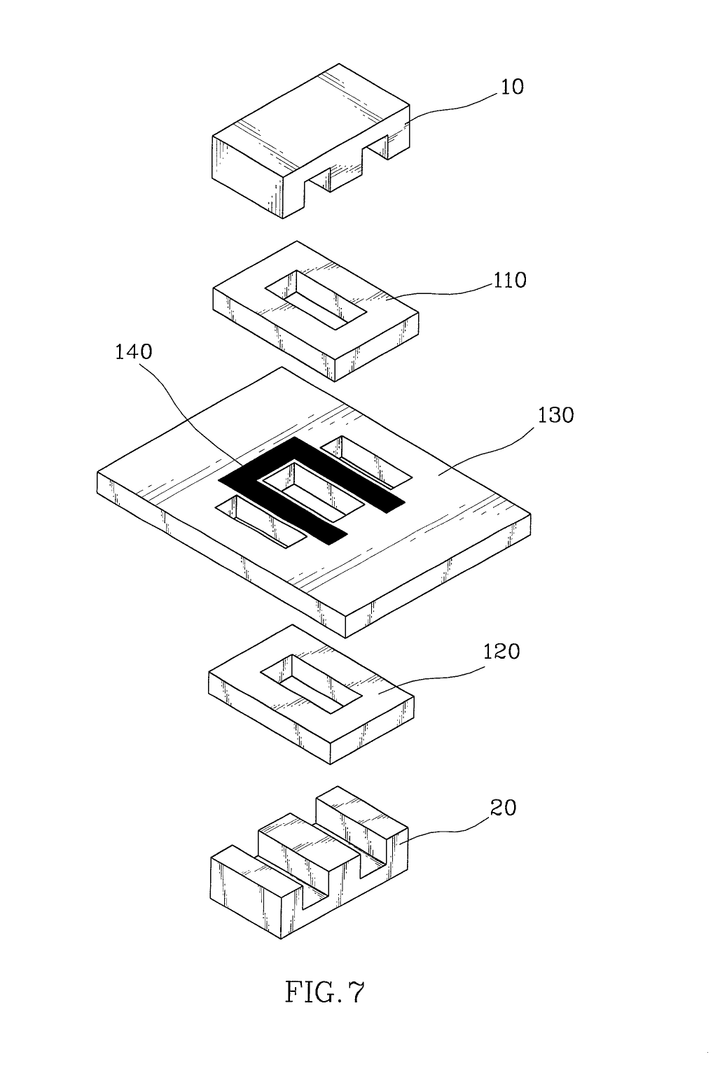

FIG. 7 is an exploded view of a low profile transformer assembly according to a fourth embodiment of the present invention. The main feature of the fourth embodiment is that the secondary windings are located on PC boards. Typically, the magnetic housing is made of ferrite, Sumarium or some other composite material shaped as EE cores, as shown in FIG. 7. In addition, the other types of ferrite cores, such as EI core, ER core, EE core, or Cut type, may also be used. Moreover, the transformer according to the fourth embodiment further contains a top module 110 and a bottom module 120. There are several spiral traces located on the modules (not shown in FIG. 7) to be operated as the primary windings. There is a hole in the middle of each module, such that the central projections of the top ferrite core 10 and the bottom ferrite core 20 can penetrate into the holes of the modules 110, 120 to form a transformer with a low profile.

On the other hand, the transformer 5 shown in FIG. 7 also contains a PC board 130, on which has a layout of a copper sheet circuits 140. There is also a hole in the middle of the PC board 130, such that the central projections of the top ferrite core 10 and the bottom ferrite core 20 can penetrate into the hole. The PC board 130 is located between the top module 110 and bottom module 120 and between the top ferrite core 10 and bottom ferrite core 20, and the circuits 140 on the PC board 130 are operated as the secondary windings of the transformer. As mentioned above, the top module 110 and the bottom module 120 are operated as the primary windings. In addition, one or multilayers of insulating layers could be inserted into the transformer, in order to prevent short-circuiting from the primary windings to secondary windings.

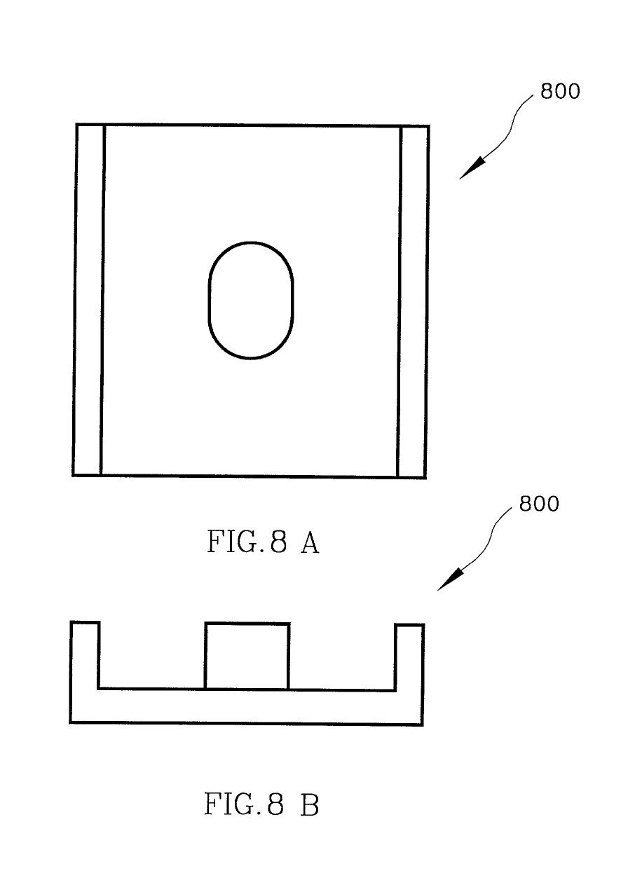

The energy loss of the transformer will be larger when commercial ferrite cores are used. Therefore, a novel design for ferrite cores is needed to obtain a transformer with good performance and low energy loss. Referring now to FIG. 8A, it is the top view of the new ferrite core 800 according to the new ferrite core 800.

FIG. 9 is a side view of a low profile transformer assembly according to a fifth embodiment of the present invention. This embodiment is similar to the first embodiment, except for the use of triple insulation wires for the secondary winding 70 in order to prevent short-circuiting between the primary winding and the secondary winding. The leads of the secondary winding 70 extend outwardly for a distance known as the “creepage” distance 750 in order to conform to the required safety standards. The “creepage” distance is the shortest path along the surface of insulating material between two non-insulated parts. The “creepage” distance separates the soldered portions 710 of the leads 70 from the other uninsulated portions of the transformer.

As mentioned above, the transformer according to the present invention has the advantages of low profile, easy to form the primary windings and the secondary windings, and available for any kind of ferrite cores.

It is to be understood that although the present invention has been described with reference to particular preferred embodiments, it should be appreciated that numerous modifications, variations and adaptations may be made without departing from the scope of the invention as defined in the claims.

I claim:

1. A low profile transformer comprising:
(a) a top core and a bottom core defining a magnetic path, wherein each said core has a central projection;
(b) a top PC board and a bottom PC board with several of spiral traces as primary windings of said transformer, wherein each said PC board has a hole in the middle, such that said central projections of said cores can penetrate into said holes of said PC boards to form a structure with low profile; and
(c) an insulation wire, wherein said insulation wire is wound round said central projections of said cores as secondary windings of said transformer and leading ends of the insulation wire are wound with triple insulation.

2. The low profile transformer of claim 1, wherein said cores are sandwiched by said PC boards and said insulation wire, so that the height of said transformer is just a combination of said cores.

3. The low profile transformer of claim 1, further including a top insulating layer and a bottom insulating layer, wherein said top insulating layer is located between said top core and said top PC board, and said bottom insulating layer is located between said bottom core and said bottom PC board.

4. The low profile transformer of claim 1, further including a couple of insulators, wherein said insulators are located between said PC boards and said insulation wire to avoid said primary windings from being short to said secondary windings.

5. The low profile transformer of claim 1, further including a couple of fix rods, wherein said fix rods are located at one side of said top PC board and said bottom PC board, in order to fix said PC boards.

6. The low profile transformer of claim 1, wherein said insulation wire is made of copper sheet and directly coated on a PC board as said secondary winding, the copper sheet having a thickness of less than 0.4 mm.

7. The low profile transformer of claim 6, further including a couple of insulators adjacent to said secondary winding of said transformer.

8. A low profile transformer comprising:
(a) a top core and a bottom core defining a magnetic path, wherein each said core has a central projection;
(b) a top PC board and a bottom PC board with several of spiral traces as primary windings of said transformer, wherein each said PC board has a hole in the middle, such that said central projections of said cores can penetrate into said holes of said PC boards to form a structure with low profile;
(c) an insulation wire, wherein said insulation wire is wound around said central projections of said cores as a secondary winding of said transformer, and wherein leading ends of the insulation wire are wound with triple insulation;
(d) a top insulating layer and a bottom insulating layer, wherein said top insulating layer is located between said top core and said top PC board, and said bottom insulating layer is located between said bottom core and said bottom PC board; and
(e) said cores are sandwiched by said PC boards and said insulation wire, so that the height of said transformer is just a combination of said cores.

9. The low profile transformer of claim 8, wherein said cores are EE cores.

10. The low profile transformer of claim 8, wherein said cores are El cores.

11. The low profile transformer of claim 8, wherein said cores are ER cores.

12. The low profile transformer of claim 8, wherein said cores are cut cores.

13. The low profile transformer of claim 8, wherein said cores are any type of ferrite cores.

14. The low profile transformer of claim 8, wherein said insulation wire is made of copper sheet and directly coated on a PC board as said secondary winding.

15. A low profile transformer comprising:
(a) a top core and a bottom core defining a magnetic path, wherein each said core has a central projection;
(b) a top module and a bottom module, wherein each said module has several of spiral traces as primary windings;
(c) a PC board with several of spiral traces as secondary windings of said transformer, wherein said PC board has a hole in the middle, such that said central projections of said cores can penetrate into said hole; said PC board is located between said top core and said bottom core, and between said top module and said bottom module; and
(d) said top core and said bottom core work as said primary windings, and said secondary windings are on said PC board.

16. The low profile transformer of claim 15, further including a couple of insulators, wherein each said insulator is located between one of said module and one of said PC board.
